(19) United States
(12) Patent Application Publication
(10) Pub. No.: US 2011/0040834 A1
(43) Pub. Date: Feb. 17, 2011

(54) ARCHIVING CONTENT IN A CALENDARED EVENT

(75) Inventors: STEPHEN PAUL SCHAEFER, CEDAR PARK, TX (US); KEITH BRITTON NELSON, AUSTIN, TX (US); CAROLYN JAYNE KILDAY, AUSTIN, TX (US)

Correspondence Address: WONG, CABELLO, LUTSCH, RUTHERFORD & BRUCCULERI,;L.L.P., 20333 SH 249 6th Floor, HOUSTON, TX, 77070, US

(73) Assignee: POLYCOM, INC, PLEASANTON, CA (US)

(21) Appl. No.: 12/542,331

(22) Filed: Aug. 17, 2009

(51) Int. Cl. G06F 15/16; G06Q 10/00; G06F 12/00; G06F 12/16

(52) U.S. Cl. 709/204; 705/9; 711/162; 709/206; 711/E12.001; 711/E12.103

(57) ABSTRACT

Systems and methods of providing access to meeting content via an interface to meeting scheduling software are described. A meeting organizer schedules a meeting or conference meeting with selected participants. The meeting is held with the available participants and meeting content is automatically maintained as an association to a calendar entry in the meeting scheduling software. After the meeting is completed, available participants may review content and unavailable participants (those that were unable to attend) may view the content of the meeting. Participants may further be able to augment the meeting content and make the augmented content available to all meeting participants via a historical calendar entry.

### FIELD OF THE DISCLOSURE

This disclosure relates generally to the field of video conferencing. More particularly, but not by way of limitation, this disclosure relates to a method of providing an interface between a meeting scheduling system and equipment utilized to facilitate the meeting whereby content shared during or after the meeting may be automatically archived and then shared via the meeting scheduling system interface.

### BACKGROUND

In today's corporate environment, it is typical to schedule meetings via meeting scheduling software. The meeting scheduling software sends a message to “meeting invitees” and usually allows for automatic creation of a calendar entry in the invited participants personal calendar. Examples of meeting scheduling software include MobileMe available from Apple Inc., Cupertino, Calif. (MobileMe is a registered trademark of Apple Inc.); Google Calendaring available from Google, Inc., Mountain View, Calif.; Mozilla Sunbird available from Mozilla Corporation, Mountain View, Calif,; and Microsoft Outlook/Exchange available from Microsoft Corporation, Redmond, Wash.

Presently, to access content from a meeting (e.g., notes, presentations, audio, transcripts, documents, and video recordings) after a meeting the content needs to be saved and manually placed in a location for sharing amongst participants. This requires a person to email the documents to the meeting invitees or post the documents in a shared location. After the documents are placed in a shared location, security constraints pertaining to the shared location should be considered. Special consideration must be taken into account if access to the meeting content is restricted to meeting participants. This shared location may be a Wiki site, a Sharepoint site, or simply a shared network directory.

When a meeting invitee who was unable to attend the meeting desires access to these documents, that person needs to search the possible locations or retrieve an email sent after the meeting. Furthermore, if no one posts the content or if no one sends out information about where the content is posted it may be difficult, if not impossible, to find the stored meeting content.

What is needed is a method and system to provide an interface to meeting scheduling software such that meeting content may be easily retrieved either before (pre-meeting information) or after (post meeting information including an optional recording of the meeting) the meeting has occurred. It would also be desirable for this information to be automatically made available via the regular interface to the scheduling software (e.g., via a plug-in or extension to the regular interface software).

### SUMMARY

In one embodiment, a conferencing device is configured with a programmable control device. The programmable control device is programmed to receive indications of calendar events and data associated with the calendar event. Upon receipt of the location of data the programmable control device automatically adds information to the calendar entry such that meeting invitees may be able to access the information directly from their interface to the meeting scheduling software. The data associated with the calendar event may include actual recordings of audio, video and or data that was shared with meeting participants able to attend the meeting. Those meeting invitees that were unable to attend the original meeting may also gain easy access to the information presented or recorded during the actual conference.

In another embodiment, a method of maintaining meeting content is disclosed. A meeting scheduler (i.e., organizer) creates a meeting entry in meeting scheduling software. The organizer invites meeting participants and those able to attend conduct a meeting or a conference. Any content recorded during the meeting is associated to the original meeting invite automatically such that meeting participants and unavailable invites may have access to the meeting content via the original calendar entry created in the meeting scheduling software.

### BRIEF DESCRIPTION OF THE DRAWINGS

FIG. 1 shows, in block diagram form, an exemplary network of supporting equipment for one embodiment of this disclosure.

FIG. 2 shows, in flowchart form, a process for scheduling, collecting, and updating information about conference meeting content for meeting participants.

FIG. 3 shows a screen shot of a representation of a single calendar entry for a meeting.

FIG. 4 shows a screen shot of a representation of a weekly view from a client interface to meeting scheduling software.

FIG. 5 shows, in block diagram form, an exemplary conferencing device comprising a programmable control device.

### DETAILED DESCRIPTION

Methods, devices and systems to maintain content information in an associated calendar meeting entry are described. A calendar meeting entry can be graphically represented as a meeting notice in a display interface of calendaring and scheduling software. Calendaring and scheduling software typically provides services such as appointment scheduling, room scheduling, meeting scheduling, facility scheduling and employee scheduling. Meetings may be scheduled and may possibly be recurring or they may be created ad hoc with the video and/or audio portion of the call being automatically posted to a calendar entry at the end of the meeting. Disclosed is a method and systems to provide an interface to meeting scheduling software such that meeting content may be easily retrieved either before (pre-meeting information) or after (post meeting information including an optional recording of the meeting) the meeting has occurred. In one disclosed embodiment, this information is made available from the regular interface to the scheduling software (e.g., via a plug-in or extension to the regular interface software). Although the methods and systems disclosed herein may at times refer to the Microsoft Outlook client and the Microsoft Exchange server, one of ordinary skill in the art, given the benefit of this disclosure, will recognize the inventive concepts disclosed herein are applicable to different calendaring and scheduling software implementations.

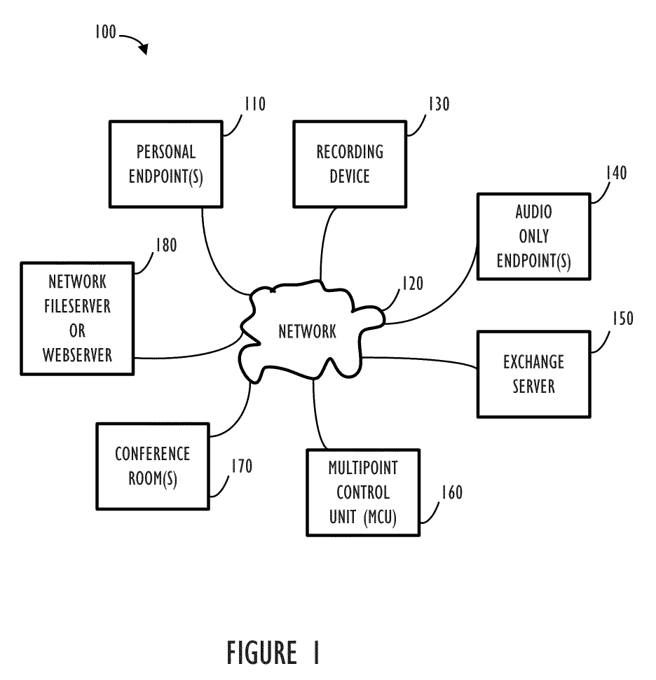

FIG. 1 shows, in block diagram form, exemplary equipment 100 available to a corporation for facilitating a meeting. The meeting may take place at a single location or between multiple locations with potentially differing numbers of participants at the different locations. When participants of a meeting are not all at one location, a conference can be initiated to connect the multiple locations. A conference may be an audio only conference, a video conference, a data conference or a combination thereof. In one type of hybrid conference some locations can have full audio and video while other locations may be limited to audio only or be able to receive video and only supply audio (e.g., video from a computer over a network and audio via a telephone).

As shown in FIG. 1, each of the different types of equipment available to support a meeting can be communicatively coupled via network 120. Network 120 represents multiple network types and network technologies known to those of skill in the art (e.g., POTS, Ethernet, TCP/IP, packet switched, circuit switched, cellular, LAN and WAN). Each of the different types of equipment shown in FIG. 1 represents a logical capability and each of these logical capabilities may be combined and provided by a single physical device. Also, each of the different types of equipment may or may not include a programmable control device capable of being programmed to provide extended capabilities to the equipment via software, middleware or firmware, etc.

FIG. 1 shows a personal endpoint 110. Each of a potential plurality of personal endpoints 110 may include a personal conferencing system or optionally a camera input device connected to a personal computer. A single personal endpoint 110 may be used by a single participant of a conference or in some cases may support a small number of people. A personal computer acting as a personal endpoint 110 can include a processor that has been specifically programmed with software allowing it to connect to and participate in a conference. One examples of such software is the CMA Desktop Video Soft Client available from Polycom Inc., Pleasanton, Calif.

FIG. 1 also shows a recording device 130 communicatively coupled to network 120. Recording device 130 can allow for recording the audio portion of the conference or the audio and video portion of the conference. Recording device 130 can be configured to record the data from selected video capture devices (e.g., camera) or all video capture devices supporting a conference. Recording device 130 may further contain a programmable control device programmed to interface recording device 130 with other devices connected to network 120. In particular, recording device 130 may be programmed to provide information and recorded content to network fileserver or webserver 180 and/or exchange server 150. Furthermore, recording device 130 may be integrated into the same physical device providing other logical capabilities shown in FIG. 1. Examples of recording device 130 include the recording and streaming server RSS™ 2000 and the Polycom Video Media Center (VMC) 1000 each available from Polycom, Inc., Pleasanton, Calif. (RSS is a registered trademark of Polycom, Inc.).

Next, FIG. 1 shows an audio only endpoint 140 communicatively coupled to network 120. Audio only endpoint(s) 140 represent endpoints where a conference participant may have limited conferencing network devices. For example, a participant may be connected to the conference via a cellular phone because they are traveling or may only be able to connect to the conference via a traditional land line telephone. In other instances, a conference participant may be equipped with both an audio only endpoint 140 and a personal computer acting as a personal endpoint 110, which can view meeting content. However, in this example the personal computer acting as a personal endpoint 110 is not configured to receive or provide audio. Therefore, the combination of personal endpoint 110 and audio only endpoint 140 work together for a conference participant.

Exchange server 150 is an example server to support one implementation of meeting scheduling software. Exchange server 150 is communicatively coupled to network 120. Exchange server 150 can be configured to support a meeting scheduling client application (e.g., Microsoft Outlook (not shown)) providing a calendar type interface to end users. End users of a network in a corporate environment are typically a superset of the users invited to a meeting (i.e., meeting invitees) and potentially become conference participants. As used herein, “meeting invitees,” includes all of the people receiving an invitation to the meeting. In some cases, these people will be selected by the meeting organizer while in other cases original invitees may forward the meeting invite to additional people.

Multipoint Control Unit (MCU) 160 is also communicatively coupled to network 120. Multipoint audio and/or multimedia calls are typically scheduled in advance through companies that own MCUs or audio bridges. An MCU 160 provides the capability for three or more terminals to participate in a multipoint audio and/or multimedia conference. An audio bridge provides the capability for three or more terminals to participate in a multipoint audio conference. In this disclosure the term MCU may also refer to an audio bridge used for multipoint audio conferences; therefore, in the description words such as MCU and audio bridge may have the same meaning. A terminal is an end-point on a network, capable or real-time, two-way audio, data and/or visual communication with other terminals or an MCU 160. The information communicated between the terminals and/or the MCU 160 includes control signals, indicators, audio moving color video pictures and/or data. A terminal may provide speech only, speech and data, speech and video, or speech, data and video. One or more MCUs 160 may be configured to support a conference. One example of an MCU 160 is the MGC+100 provided by Polycom Inc., Pleasanton, Calif.

One or more conference rooms 170 may also be utilized during a conference. These conference rooms 170 may be physical conference rooms where meeting participants are physically present and in the proximity of cameras, microphones or other conference supporting equipment. Additionally, conference rooms 170 may be virtual conference rooms where participants are not physically located but are logically grouped such that they appear to other participants as if they were in the same conference room. In each implementation of conference room 170 there are devices communicatively coupled to network 120.

Network file server or webserver 180 represents a server configured to store and share meeting content. In one embodiment, meeting content may be stored on the Exchange server 150. In another preferred embodiment, Exchange server 150 is not utilized to store actual content from the meeting but instead stores a link (e.g., Universal Resource Locator, URL) pointing to a storage server (e.g., network fileserver or web server 180). In this preferred embodiment the Exchange server is off loaded of the responsibility for storing possibly voluminous meeting content and allowed to support its primary function of Exchange/Outlook support.

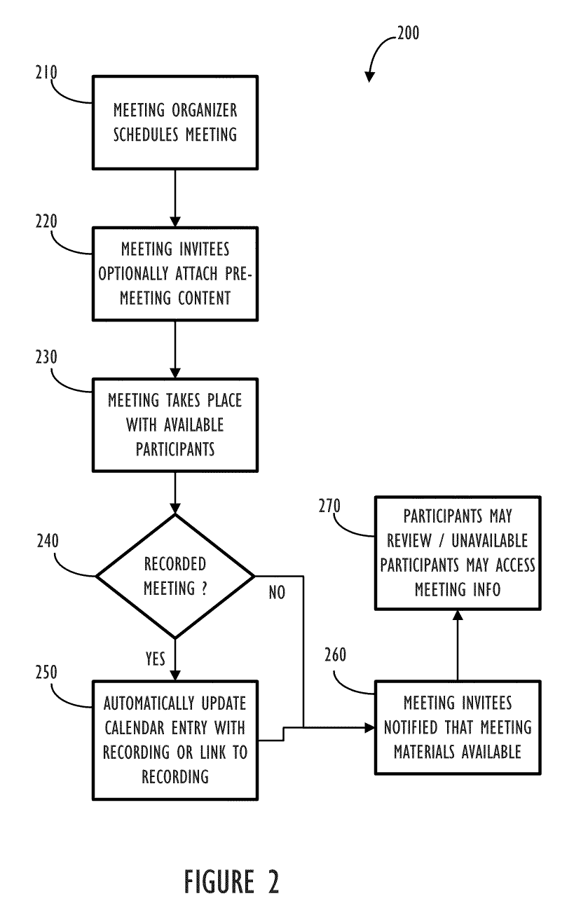

Referring now to FIG. 2, process 200 shows a possible work flow for scheduling and conducting a meeting or a conference. First, at block 210 a meeting organizer schedules a meeting via meeting scheduling software. When the meeting organizer decides to organize a meeting which includes a number of human participants, he may use his Outlook client to organize the meeting by inviting participants. During the process of creating the meeting invitation, the organizer may decide to include video conferencing in the meeting. He may also decide to include one or more physical conference rooms in the invitation. The organizer may also indicate to record the meeting if recording capabilities are present to facilitate the meeting. After organizing the meeting, the organizer sends the invitation to all meeting invitees. The organizer is able to receive accept/decline responses from all human participants, and possibly the conference room(s), virtual meeting rooms, recording system. If necessary, the organizer can change the time, or location of the meeting, and send updates.

Next, at block 220 meeting invitees may optionally attach pre-meeting content to the calendar entry and thus provide easy access to this content either before or during the meeting. Pre-meeting content may include slide presentations, other office documents, meeting agenda and meeting preparation materials. At the scheduled time of the meeting, block 230, the meeting takes place with the available participants. At block 240, it is determined if the meeting content (e.g., audio and/or video) was recorded. If so, the YES prong of block 240, flow continues to block 250 where the calendar entry is automatically updated with a copy of the recorded information or a link to the recorded information. Those of skill in the art will recognize that links may include but are not limited to, hyperlinks, icons or thumbnail representations indicating content corresponding to the meeting. If the meeting content is not recorded, the NO prong of block 240, flow continues directly to block 260. At block 260 the meeting has concluded and if necessary meeting invitees are notified that meeting materials are available. Flow then continues to block 270 where meeting participants may review the meeting information or unavailable meeting invitees (i.e., invitees that were not able to attend the actual meeting) can review meeting materials and replay any recorded content from the conference. One of ordinary skill in the art will also recognize, given the benefit of this disclosure, that a review of meeting materials may take place from several different types of devices, including but not limited to, individual computer workstations or other exemplary video conferencing devices equipped with an interface to the calendar scheduling software or an interface to email software.

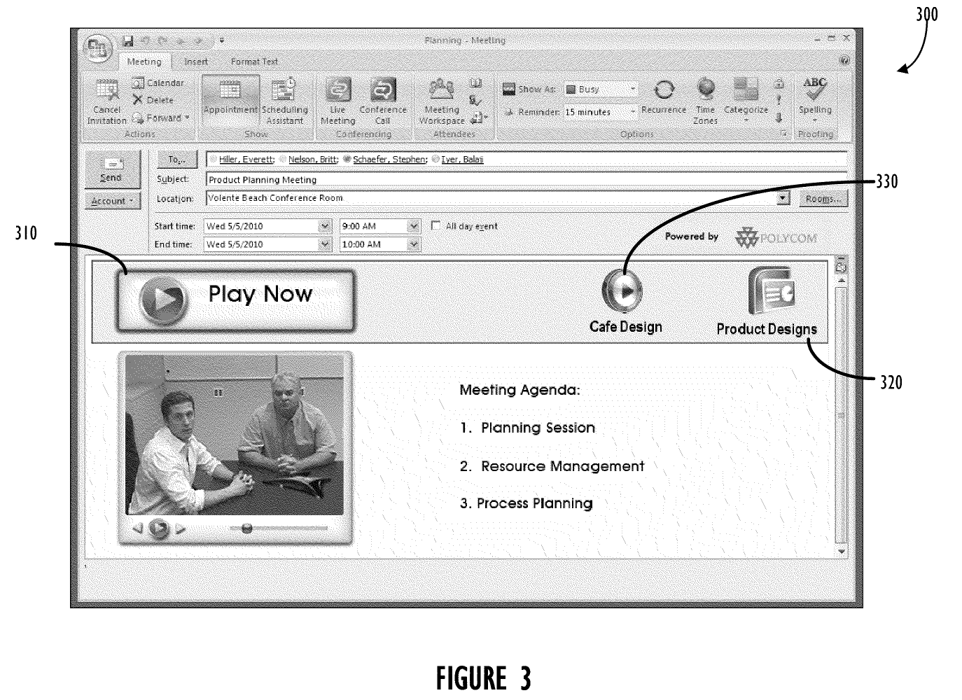

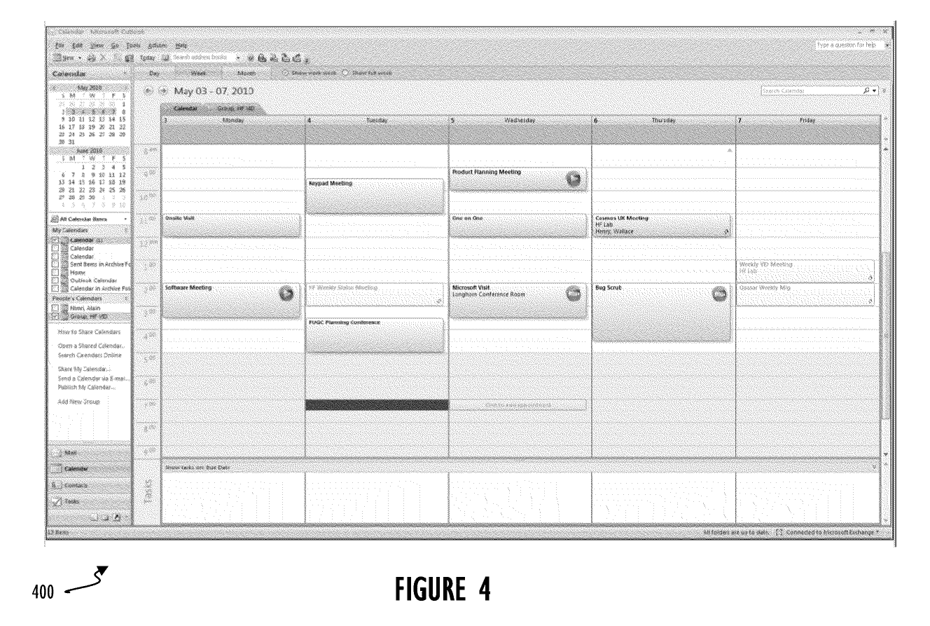

Referring now to FIGS. 3 and 4 example views into a meeting scheduling application are shown. FIG. 3 shows a single calendar entry 300. Calendar entry 300 contains icon 310 which is a play button to replay the information recorded in the conference. Icon entries 320 and 330 represent other data associated with calendar entry 300. FIG. 4 shows a weekly view 400 (i.e., Monday through Friday) consisting of multiple calendar entries for each day.

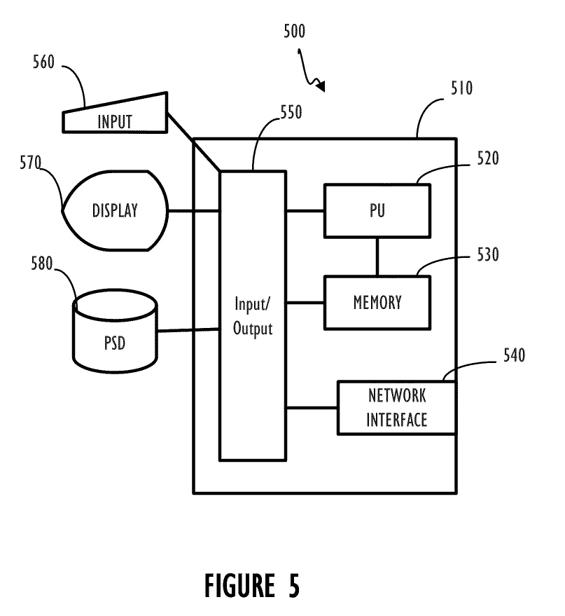

Referring now to FIG. 5, an exemplary conferencing device 500 is shown. Exemplary conferencing device 500 comprises a programmable control device 510 which may be optionally connected to input 560 (e.g., keyboard, mouse, touch screen, etc.), display 570 or program storage device (PSD) 580. Also, included with program device 510 is a network interface 540 for communication via a network with other conferencing and corporate infrastructure devices (not shown). Note network interface 540 may be included within programmable control device 510 or be external to programmable control device 510. In either case, programmable control device 510 will be communicatively coupled to network interface 540. Also note program storage unit 580 represents any form of non-volatile storage including, but not limited to, all forms of optical and magnetic storage elements including solid-state storage. Examples of conferencing device 500 include but are not limited to, personal computers, video conferencing endpoints, video conferencing data recorders, and MCUs.

Program control device 510 may be included in a conferencing device and be programmed to perform methods in accordance with this disclosure (e.g., those illustrated in FIG. 2). Program control device 510 comprises a processor unit (PU) 520, input-output (I/O) interface 550 and memory 530. Processing unit 520 may include any programmable controller device including, for example, the Intel Core®, Pentium® and Celeron® processor families from Intel and the Cortex and ARM processor families from ARM. (INTEL CORE, PENTIUM and CELERON are registered trademarks of the Intel Corporation. CORTEX is a registered trademark of the ARM Limited Corporation. ARM is a registered trademark of the ARM Limited Company.) Memory 530 may include one or more memory modules and comprise random access memory (RAM), read only memory (ROM), programmable read only memory (PROM), programmable read-write memory, and solid state memory. One of ordinary skill in the art will also recognize that PU 520 may also include some internal memory including, for example, cache memory.

Aspects of the invention are described as a method of control or manipulation of data, and may be implemented in one or a combination of hardware, firmware, and software. Embodiments of the invention may also be implemented as instructions stored on a machine-readable medium, which may be read and executed by at least one processor to perform the operations described herein. A machine-readable medium may include any mechanism for tangibly embodying information in a form readable by a machine (e.g., a computer). For example, a machine-readable medium (sometimes referred to as a program storage device or a computer readable medium) may include read-only memory (ROM), random-access memory (RAM), magnetic disc storage media, optical storage media, flash-memory devices, electrical, optical, and others.

In the above detailed description, various features are occasionally grouped together in a single embodiment for the purpose of streamlining the disclosure. This method of disclosure is not to be interpreted as reflecting an intention that the claimed embodiments of the subject matter require more features than are expressly recited in each claim.

Various changes in the details of the illustrated operational methods are possible without departing from the scope of the following claims. For instance, illustrative flow chart steps of FIG. 2 may perform the identified steps in an order different from that disclosed here. Alternatively, some embodiments may combine the activities described herein as being separate steps. Similarly, one or more of the described steps may be omitted, depending upon the specific operational environment the method is being implemented in. In addition, acts in accordance with FIG. 2 may be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs”) or field programmable gate array (“FPGAs”). Storage devices, sometimes called computer readable medium, suitable for tangibly embodying program instructions include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A method of archiving information from a conferencing device into a calendar entry of meeting scheduling software, the method comprising:
receiving parameters for a scheduled conference from meeting scheduling software, executing on a programmable processing device, indicating a calendar entry;
receiving an indication of information recorded on a recording device pertaining to the scheduled conference; and
initiating an automatic update of the calendar entry with an indication of the recorded information.

2. The method of claim 1 further comprising:
archiving the recorded information from the recording device to a storage server prior to automatically updating the calendar entry with an indication of the recorded information.

3. The method of claim 1 wherein the calendar entry is automatically updated after the scheduled conference has concluded.

4. The method of claim 3 wherein the automatic update to the calendar entry causes an email notification associated with the update to meeting invitees.

5. The method of claim 4 wherein the meeting invitees are further able to review content associated with the scheduled conference directly from the email notification.

6. The method of claim 3 wherein a calendar entry and associated content from the scheduled conference may be reviewed from a conferencing device.

7. The method of claim 1 wherein the calendar entry is automatically updated prior to the scheduled conference beginning.

8. The method of claim 1 wherein the calendar entry is automatically updated while the scheduled conference is in progress.

9. The method of claim 1 wherein the meeting scheduling software is Microsoft Outlook/Exchange.

10. A conferencing device, the conferencing device comprising:
a programmable control device; and
a network interface;
wherein the conferencing device is communicatively coupled to a network via the network interface and the programmable control device is programmed to:
receive an indication of a calendar entry;
receive an indication of recorded content associated with the calendar entry; and
initiate an automatic update to the calendar entry with an indication of the recorded content.

11. The conferencing device of claim 10 wherein the programmable control device is further programmed to:
initiate an archival of the recorded content to a storage server; and
initiate an automatic update to the calendar entry with an indication of the recorded content relative to the storage server.

12. The conferencing device of claim 10 wherein the programmable control device is further programmed to initiate an automatic update to the calendar entry after a scheduled conference has concluded.

13. The conferencing device of claim 10 wherein the programmable control device is further programmed to initiate an automatic update to the calendar entry prior to a scheduled conference beginning.

14. The conferencing device of claim 10 wherein the programmable control device is further programmed to initiate an automatic updated to the calendar entry while a scheduled conference is in progress.

15. A program storage device with instructions for controlling a programmable control device stored thereon to configure the programmable control device to perform the method of claim 1.

16. A method of retrieving recorded information associated with a conference and corresponding to a calendar entry, the method comprising:
selecting an item presented in the calendar entry wherein the calendar entry has been automatically updated with the item and the item provides an indication of recorded information associated with the conference.

17. The method of claim 16 wherein the recorded information is audio from the conference.

18. The method of claim 16 wherein the recorded information is video from the conference.

19. The method of claim 16 wherein the recorded information is data from the conference.

20. A computer system configured to provide meeting scheduling software, the computer system comprising a programmable control device;
a network interface; and
a software plug-in to scheduling software;
wherein the computer system is communicatively coupled to a network via the network interface and the programmable control device is programmed to perform a meeting scheduling function; and
wherein the software plug-in is configured to:
receive an indication of a calendar entry;
receive an indication of recorded content associated with the calendar entry; and
initiate an automatic update to the calendar entry with an indication of the recorded content.
